(19) United States
(12) Patent Application Publication
(10) Pub. No.: US 2002/0023027 A1
(43) Pub. Date: Feb. 21, 2002

(54) Method and system of effecting a financial transaction

(76) Inventor: Grant Simonds, Victoria (AU)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/932,667

(22) Filed: Aug. 17, 2001

Related U.S. Application Data
(60) Provisional application No. 60/252,000, filed on Dec. 7, 2000.

(30) Foreign Application Priority Data
Aug. 18, 2000 (AU) PQ9524

(51) Int. Cl. G06F 17/60

(52) U.S. Cl. 705/26

(57) ABSTRACT

A method of providing a purchaser with a confirmation of a transaction includes providing the purchaser with an electronic machine-readable image, such that the electronic image may be displayed on a screen of a portable or handheld electronic device to verify the transaction. The image may be any displayable and visually readable indicia. The system includes a transaction validation device for issuing the electronic machine-readable image in response to a financial transaction, a network interface means, and a portable or handheld electronic device for receiving the electronic machine-readable image for display on the screen of the portable or handheld electronic device to verify the transaction. The system also preferably includes an optical scanner for reading the barcode image from the display.

### CROSS-REFERENCE TO RELATED APPLICATION

This application is related to, and claims priority from, Australian Provisional Application No. PQ9524 entitled “IMPROVED METHOD AND SYSTEM OF EFFECTING A FINANCIAL TRANSACTION” filed on Aug. 18, 2000, and U.S. Provisional Application No. 60/252,000 entitled “IMPROVED METHOD AND SYSTEM OF EFFECTING A FINANCIAL TRANSACTION” filed on Dec. 7, 2000, the disclosures of which are incorporated herein by reference.

### BACKGROUND

The present invention relates to the field of electronic commerce, particularly financial transactions carried out by electronic means, such as the buying or selling of goods/services using portable or handheld electronic means. In one particular form, the present invention relates to electronic ticketing, and proof of purchase via a mobile phone or other portable device.

There is a large body of prior art that relates to various ticketing systems and especially e-ticketing systems. A still relatively large body of prior art relates to these types of ticketing and financial transaction systems using mobile phone technology as at least a part of the overall system.

However, the majority of these disclosures outline various communication systems for effecting electronic transactions in which an email or an alphanumeric or coded receipt number is transmitted to the mobile phone and is used to confirm that the transaction is completed. Example disclosures can be found in U.S. Pat. Nos. 5,948,040. 5,920,826 and 5,608,778.

There also exists a large body of prior art disclosures that deal with alternate barcode technology. This is a relatively well-established art. In this respect, the barcode sometimes performs a number of various functions or tasks. An example is U.S. Pat. No. 4,850,009. In some of the art, bar-coding is used for recording telephone numbers in which the barcode was only used for storage and required a plug-in bar-code reader to interact with the phone. These patents related more to dialing methods.

In much of the other barcode related prior art, the disclosures are directed to a paper based technology, and thus the disclosures related to financial transactions relates to a paper ticket form of ticket or coupon upon which the barcode is actually printed.

When tickets for events (such as sport or theater) have been purchased using E-Commerce there is a need to print out a ticket on paper prior to entering the venue so that the venue staff can verify that the patron has paid the entry fee. In some cases this printed ticket includes a bar code so that the venue staff can use an electronic verification system to quickly check that the ticket is unique.

### SUMMARY

According to one aspect, the present invention provides a method of providing a purchaser with a confirmation of a transaction including the step of providing the purchaser with an electronic machine-readable image, such that the electronic image may be displayed on the screen of a portable or handheld electronic device to verify the transaction.

The image may be a displayable and visually readable indicia.

According to another aspect, the present invention provides a system comprising a transaction validation device for issuing an electronic machine-readable image in response to a financial transaction; network interface means; and a portable or handheld electronic device for receiving the electronic machine-readable image for display on a screen of the portable or handheld electronic device to verify the transaction.

Preferably, the system also includes an optical scanner for reading the barcode image from the display.

In a further aspect, the present invention provides a method of verifying a purchase of goods/services, such as tickets to an entertainment event, including the step of scanning a machine-readable image which is electronically displayed on a portable or handheld electronic device, such that access to the goods/services will be provided, where the scanning step confirms the purchase or ordering of the goods/services.

A number of further preferable steps are disclosed which relate to verification of the barcode or ticket displayed, and deal with possible attempts to utilize the invention fraudulently.

The machine-readable images, such as barcodes, are displayed on portable electronic devices, such as mobile phones, as validation, verification or confirmation of a commercial transaction. The present invention serves to provide a means to show that a commercial transaction has taken placed by the use of a machine-readable image or indicia provided on a portable electronic device.

### BRIEF DESCRIPTION OF THE DRAWINGS

Preferred embodiments of the present invention will now be described with reference to the accompanying drawings, in which:

FIG. 1 illustrates a barcode displayable in relation to the present invention,

FIGS. 2a, 2b and 2c illustrate a barcode displayed on a number of different portable devices according to an embodiment of the present invention, and

FIG. 3 illustrates an overall schematic of an embodiment of the present invention.

### DETAILED DESCRIPTION

According to a first embodiment of the present invention, a mechanism for purchasing tickets for events, such as a sports event or a theatre event, is described. The actual purchase of the tickets may take place by any means, although the present invention is particularly suited to e-commerce transactions.

In this regard, once a user has requested purchase of tickets and payment, such as by credit, has been verified by the vendor, a machine-readable image will be electronically generated by or on behalf of the vendor and made available to the user. Preferably this machine-readable image is a barcode.

The barcode (FIG. 1) would be provided to the user in an electronic format so that it may be displayed on the user's portable electronic device, such as a personal digital assistance (PDA), mobile terminal or a mobile telephone. It is to be noted that any form of displayable and visually readable device or indicia could be used in accordance with the present invention. The barcode, which is one embodiment only of displayable and visually readable indicia, may be sent wirelessly to the user's portable device using WAP (wireless application protocol) or it may be sent to any other location nominated by the user, such as to an email account. In this regard, the barcode may be sent to as an image file. From the email account, the user would be able to transfer the electronic barcode to their portable electronic device.

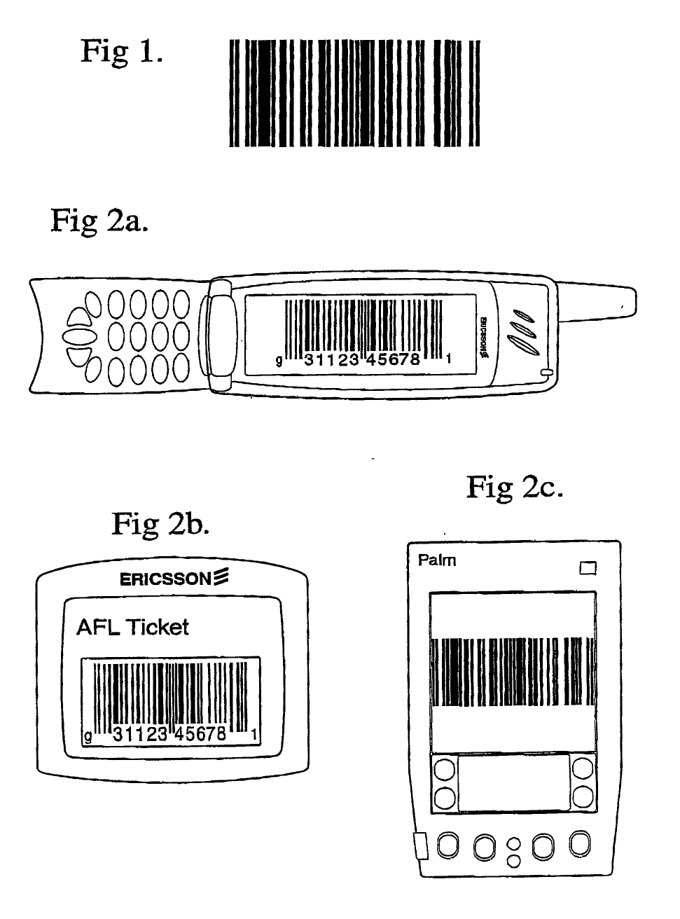

Once available on the user's portable device, the user may effectively use the electronic barcode as an electronic ticket at the event venue, providing a relatively convenient manner by which proof of purchase or validation of a financial transaction can be effected to a machine for reading images/indicia. Such a machine may, for example, be a turnstile at a sports or theater venue, or transport station. In this regard, and with reference to FIGS. 2a, 2b and 2c, the user would display the barcode on the screen of the electronic device. The displayed barcode may then be scanned by a barcode reader or other suitable image/indicia reading device at the point of ticket verification, such as when entering the event venue, as verification or confirmation of the ticket purchase.

In one preferred embodiment, it has been realized that conventional laser scanners have difficulty in repeatedly and accurately reading a barcode displayed on the screen of a mobile device, such as a mobile phone. This difficulty arises because the screen of a mobile device is usually made of liquid crystal display (LCD). A laser beam emitted from a laser scanner, when directed at a barcode, which, for example is printed on a ticket, will be reflected and absorbed by the barcode ‘stripes’ of the barcode printed on the ticket. Thus, the scanner is able to read the barcode on the basis of reflection and absorption of the laser beam by the barcode ‘stripes’, that is the lighter and darker ‘bars’, respectively.

In order to overcome this problem, it has been advantageously realized that, in accordance with another aspect of the invention, an optical based scanner can be used in association with the present invention. The optical scanner serves to take an ‘image’ of the phone or portable device display, and to analyze the image using an optical based technique, preferably coupled with software, in order to distinguish the lighter and darker areas of a barcode. The optical scanner may be a digital camera coupled with image recognition software. In effect, the optical scanner analyzes the barcode, not on the LCD, but either via image recognition, or in a medium that is better suited to optical analysis of barcode type images. One example of an optical scanner that has been found in tests to provide relatively good analysis of barcodes in connection with the present invention is made by Symbol Technologies, under the product name ‘Vision System 4000 series’.

It is envisioned that other embodiments (not shown) may incorporate the use of a laser scanner in connection with the present invention, such as a barcode displayed on a mobile phone or other portable device, which has a LCD display. This other embodiment would need the laser beam to be emitted from the laser scanner in a way that the beam is attenuated when impacting on a displayed barcode, and so that the laser scanner can distinguish between the light and dark areas of a barcode when used on a LCD.

In the specification, the Figures illustrate a number of different devices with which the present invention can be used. The present invention is not to be limited to only these devices and can be used on any device having a display associated therewith, whether integral or linked separately.

In this regard, the user may simply present the displayed electronic ticket to an attendant with a bar code reader in order to gain entry to the venue, or the displayed barcode image may be read by an automated system that may be in place at the venue.

Therefore, it is apparent that the present invention eliminates the need for paper tickets to be printed and sent to purchasers. This is particularly advantageous when it is considered that the purchaser may easily misplace paper tickets. Also the present invention eliminates the time delay in sending paper tickets to purchasers or in the purchaser queuing to pick up paper tickets before entering an event venue.

Further, the present invention may be particularly advantageous to a person who is running late for an entertainment event and wants to purchase tickets on the way to the event. If their portable electronic device were WAP enabled, they would be able to use the device to remotely purchase a ticket, such as from an Internet site or through a phone booking service. Once the vendor had verified the purchase, a barcode would be wirelessly transmitted to the user's portable electronic device as confirmation of the purchase. Then, when the person enters the venue, the screen of the electronic device displaying the barcode is presented for scanning as verification that the person has purchased a ticket.

Equally, the present invention may be used to purchase tickets or other goods and/or services on-line from a vendor using the mobile terminal. The ticket purchase may include a redemption of a token or other reward. The indicia associated with the present invention may also form a part or the entire token.

The indicia may be transferred to the electronic device using a suitable electronic transmission system, such as, but not limited to, WAP, http, ftp, or other internetworking protocol.

Furthermore, the present invention may be used to purchase, say, a cricket bat on-line. The E-transaction can be done on-line, even remote from the venue where the cricket bat is to be collected. The barcode or indicia can be transmitted to the user's mobile phone. The user can then present the indicia displayed on the phone at the point of collection, as confirmation or verification of purchase, and collect the cricket bat.

The present invention not only has application to the verification of tickets for sporting, entertainment events, or other goods and/or services, but may also be used in any other situation where indicia are generated and only have a short lifetime, such as shipping packages. Also, the indicia associated with the present invention may be used as a receipt of transactions (whether electronic or ‘over the counter’), the receipt being forwarded after the transaction has been accepted.

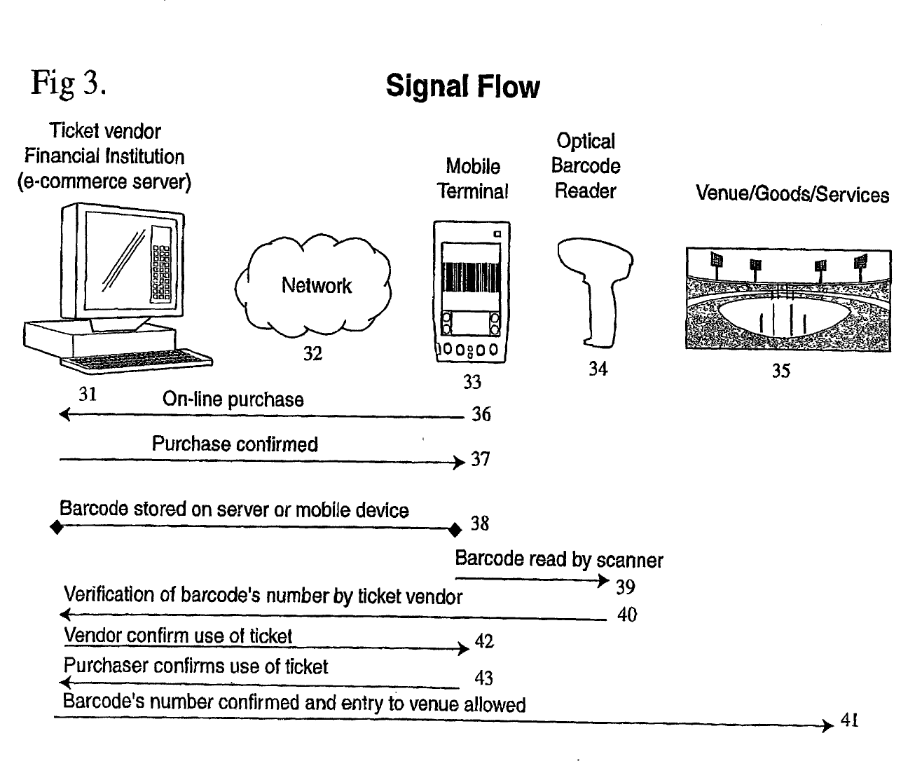

Turning to FIG. 3, an overall system diagram is schematically represented, and which includes some brief detail of signal flow related to the present invention.

Generally, a person may use a mobile terminal or other device 33, via network 32, to seek to purchase goods and/or services 35. A purchase request 36 is forwarded to a ticketing center or other vendor such as a financial institution 31 that in turn authorizes 37 the purchase. A barcode or other visually displayable and visually readable indicia 38 is generated. The barcode may be stored on the server or in the network, in which case the mobile terminal can retrieve the barcode for display on the mobile terminal at a desirable time. The barcode may, alternatively, be forwarded directly to the mobile terminal and displayed/or stored for later display on the mobile device's screen. The barcode is used as a receipt or other proof of purchase by the user. A reader 34 suitable for reading or recognizing 39 the indicia displayed on the mobile terminal is used to enable exchange of the goods and/or services between vendor and user based on the barcode displayed on the mobile device's screen.

According to another embodiment of the invention, a person may purchase goods from an online store. Then, instead of the goods being delivered by courier, which typically takes a few days for delivery, the purchaser may nominate to pick up the goods from a “bricks-and-mortar” retailer, thereby still enjoying the cost saving typically provided by buying goods on-line. Further, it may be more convenient for the purchaser to pick up the goods from an actual store in their own time.

As confirmation of the purchase, the online retailer would send to the purchaser a machine-readable image/code, such as a barcode. This barcode may once again be sent directly to the purchaser's portable electronic device, such as their mobile phone, or sent to the user by any other electronic means, so that the barcode may be transferred 38 to the mobile phone. The purchaser would then use the barcode 39 at the bricks and mortar retailer to verify the purchase and provide a list of the purchased goods for collection.

According to another embodiment of the present invention, at a point of sale, a user could use a mobile device to transfer funds or pay for goods by purchasing a barcode of specified value, which could be scanned by a trader and redeemed for the specified value. This barcode could be purchased on-line and stored and/or displayed on a mobile device. This is represented in FIG. 3 by way of signals 40 and 41, although it would be understood that the exact signals, their purpose and number/sequence would vary in accordance with the type of application to which the present invention is put.

If there are conditions of use, these could be stored by the mobile device and/or vendor and/or system. Equally, the repeated use of a barcode could be monitored and stored, if such repeated use is allowed. If repeated use is not allowed, then step 41 would deny validity of the barcode. This would also apply where the barcode, valid for only one transaction, has already been used. If it were to be used again, the vendor would deny use via step 41. A further message (not shown) could be sent to the user to inform that the barcode is no longer valid.

In a further aspect of the present invention, a number of steps can be included in the transaction process in order to better verify the authenticity of the barcode displayed on the screen of a mobile device, such as a mobile phone. In this regard, steps 42 and 43 can be performed. In the situation where a person wishes to enter a venue, the barcode would be displayed on the screen of the mobile device, as noted in step 38 of FIG. 3. This barcode would then be read or recognized 39 by an appropriate image reader 34. A request to validate the use of the barcode would then be sent at step 40. In the present aspect, enhanced verification of authenticity can be implemented by step 42, in which the vendor would, in response to step 40, ask the purchaser to verify the use of the ticket. This can be done by the vendor sending the verification to the purchaser's mobile device directly. It is to be noted that, at the time of the financial transaction at which the barcode was generated as a receipt (steps 36, 37, 38), the vendor stored or made an appropriate reference of the purchaser's mobile device number, such as mobile phone number or IMSI, or other suitable information. Thus, the vendor, knowing this information, can transmit to the mobile device directly, asking for confirmation of use of the barcode, as at step 42. The purchaser can then at step 43 confirm the use of the barcode, and gain entry to the venue, or other transaction as represented by the barcode.

If, for example, a third person fraudulently obtained a copy of a barcode from the ‘true’ owner and displayed the barcode copy on their mobile phone screen, the vendor would, via step 42, make contact with the ‘true’ owner of the barcode. The ‘true’ owner would reject the request and/or notify the vendor of the fraudulent use of the barcode copy. Because the ‘true’ owner would receive the transmission of step 42, the fraudulent user would not receive such a transmission and would be denied the ability to confirm use of the barcode. This transpires because the vendor would have details of the ‘true’ owner of the barcode only, and not of the fraudulent user. Thus, the vendor would not receive an appropriate confirmation (step 43) from the fraudulent user, and the fraudulent user would be denied access to the venue.

Equally, steps 42 and 43 could be used by the venue to verify with the vendor directly in order to verify the barcode is a valid barcode.

Nonetheless, in these alternate uses of the present invention, the principle of using a displayable and visually readable indicia, where a barcode, symbol or other indicia.

This embodiment of the invention increases the security of the transaction because the trader must scan the barcode and this guarantees that the purchaser is authenticated properly.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims.

What is claimed is:

1. A method of providing a purchaser with a confirmation of a transaction, comprising the steps of:
providing the purchaser with an electronic machine-readable image, and
displaying the image on the screen of a portable or handheld electronic device to verify the transaction.

2. The method of claim 1, wherein the electronic machine-readable image is an electronic barcode or other displayable and visually readable indicia.

3. The method of claim 1, wherein the machine-readable image is transmitted directly to a portable or handheld electronic device, such as via WAP.

4. The method of claim 1, wherein the portable device is a mobile phone.

5. The method of claim 2, wherein the portable device is a mobile phone.

6. The method of claim 1, wherein the transaction is a financial transaction.

7. The method of claim 1, wherein the image is a receipt of the transaction.

8. The method of claim 2, wherein the image is a receipt of the transaction.

9. The method of claim 4, wherein the image is a receipt of the transaction.

10. A system for facilitating a commercial transaction, the system comprising:
a transaction validation device for issuing an electronic machine-readable image or indicia in response to the commercial transaction; and
network interface means for communicating the image to a portable or handheld electronic device, wherein the portable or handheld electronic device is adapted to receive the electronic machine-readable image and display the image on a screen of the portable or handheld electronic device in a manner that will enable confirmation of the transaction.

11. The system of claim 10, wherein the electronic machine-readable image is a barcode.

12. The system of claim 10, wherein the portable or handheld electronic device is a mobile phone.

13. The system of claim 11, wherein the portable or handheld electronic device is a mobile phone.

14. The system of claim 10, wherein the transaction is a financial transaction.

15. The system of claim 10, further comprising an image reading device adapted to utilize optical image reading techniques.

16. The system of claim 11, further comprising an image reading device adapted to utilize optical image reading techniques.

17. The system of claim 15, wherein the image reading device is a digital camera operatively associated with image recognition software.

18. The system of claim 16, wherein the image reading device is a digital camera operatively associated with image recognition software.

19. A system for facilitating a transaction, the system comprising:
a machine-readable image, said machine-readable image being a receipt for the transaction, and
a portable or handheld electronic device having a screen upon which the machine-readable image is displayable,
wherein the machine-readable image is displayable on the screen in a manner that enables confirmation of the transaction by reading the image.

20. The system of claim 19, wherein the electronic machine-readable image is a barcode.

21. The system of claim 19, wherein the portable or handheld electronic device is a mobile phone.

22. The system of claim 19, wherein the commercial transaction is a financial transaction.

23. The system of claim 19, further comprising an image reading device adapted to operatively read the image using optical image reading techniques.

24. The system of claim 23, wherein the reading device is a digital camera operatively associated with image recognition software.

25. A method of verifying a purchase of goods or services, the method comprising the steps of:
scanning a machine-readable image, which is electronically displayed on a first portable or handheld electronic device such that access to the goods or services will be provided, wherein the scanning step leads to confirmation of the purchase of the goods or services.

26. The method as claimed in claim 25, further comprising the steps of:
prior to scanning the image, effecting a financial transaction to purchase the goods or services, and
receiving, by the first electronic device, the image as a receipt of the transaction.

27. The method of claim 25, further comprising the step of:
displaying the image on a display of the first device when verifying the purchase of goods or services.

28. The method of claim 25, further comprising the step of:
following the step of scanning, seeking verification of the image from the vendor in the financial transaction.

29. The method of claim 28, further comprising the steps of:
receiving a vendor's verification of the image, and
transacting in the goods or services.

30. The method of claim 29, further comprising the steps of:
prior to transacting in the goods or services, transmitting a signal to the first device from which the transaction was effected, and
seeking confirmation for approval of the transaction from the first device from which the transaction was effected.

31. The method of claim 30, wherein, if the confirmation for approval is not received from the first device, determining that the scanned image is fraudulent.
